(19) United States
(12) Patent Application Publication
(10) Pub. No.: US 2007/0009713 A1
(43) Pub. Date: Jan. 11, 2007

(54) Scored applique for instrument panels

(76) Inventor: Allen H. Hoeschele, Juneau, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/385,152

(22) Filed: Mar. 21, 2006

Related U.S. Application Data
(60) Provisional application No. 60/696,590, filed on Jul. 5, 2005.

(51) Int. Cl. B32B 3/00

(52) U.S. Cl. 428/172

(57) ABSTRACT

An improved appliqué and method of forming an appliqué having a scored and uniquely aesthetically pleasing appearance is provided. A substrate of plastic material is provided with a metallic layer. A further clear plastic, or otherwise protective coating of similar material is applied over the plastic substrate and/or metallic layer. Finely configured, score lines are formed in the appliqué to provide a unique, aesthetically pleasing appearance during normal and back-lit conditions. The score lines may be formed on the top side of the coating layer, or on the bottom side of the plastic layer.

### BACKGROUND OF THE INVENTION

The present application relates to an appliqué, instrument panel or automotive display panel decorated for day and night viewing, such as those often used in appliances, automotive dash boards and various electronics fields.

Known display panels are often designed to provide an aesthetically pleasing appearance and to provide a durable and accurate display of information to the user. It is desirable to provide an alternative appliqué, instrument panel, or automotive display panel that satisfies the continuing need for improved aesthetic appearance during both day and night viewing conditions.

### SUMMARY OF THE INVENTION

The present application provides such an improved appliqué or display panel. More particularly, an appliqué and method of forming an appliqué having a scored and uniquely aesthetically pleasing appearance is provided.

In one example, a substrate of plastic material is provided with a metallic layer, which is adhered to the bottom of the substrate. A further clear plastic, or protective coating of similar material is applied over the plastic substrate. Finely configured, score lines are formed in the appliqué to provide a unique, aesthetically pleasing appearance during normal and back-lit conditions. The score lines may be formed on the top side of the coating layer, or on the bottom side of the plastic substrate.

In another example, the metallic layer is provided on top of the plastic substrate. A further clear plastic, or protective coating of similar material is applied over the metallic layer. Finely configured, score lines are formed in the appliqué to provide a unique, aesthetically pleasing appearance during normal and back-lit conditions. The score lines may be formed on the top side of the coating layer.

### BRIEF DESCRIPTION OF THE DRAWINGS

The best mode of carrying out the invention is described with reference to the preferred embodiments depicted in the following drawing figures:

FIG. 1 is an exploded view of a protective coating, plastic substrate and metallic layer.

FIG. 2 is a perspective view of the protective coating, plastic substrate and metallic layer adhered together.

FIG. 3 is an exploded view of a protective coating, metallic layer, and plastic substrate.

FIG. 4 is a perspective view of the protective coating, metallic layer and plastic substrate adhered together.

FIG. 5 is a view of an appliqué and a scoring apparatus.

FIG. 6 is a view of score lines on the appliqué shown in FIG. 5.

FIG. 7 is a view of a formed appliqué that is back-lit.

FIG. 8 is a view of a formed appliqué.

FIG. 9 is the arrangement shown in FIG. 8 and a scoring apparatus.

### DETAILED DESCRIPTION OF THE PREFERRED EMBODIMENTS

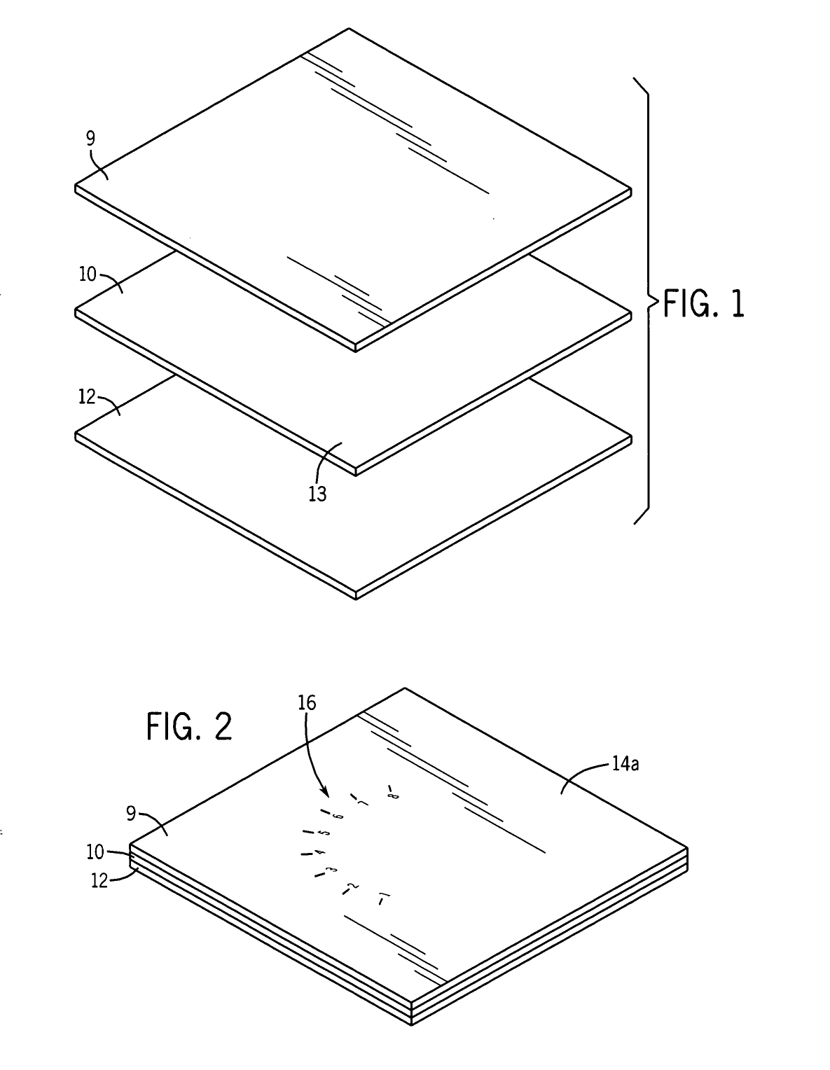

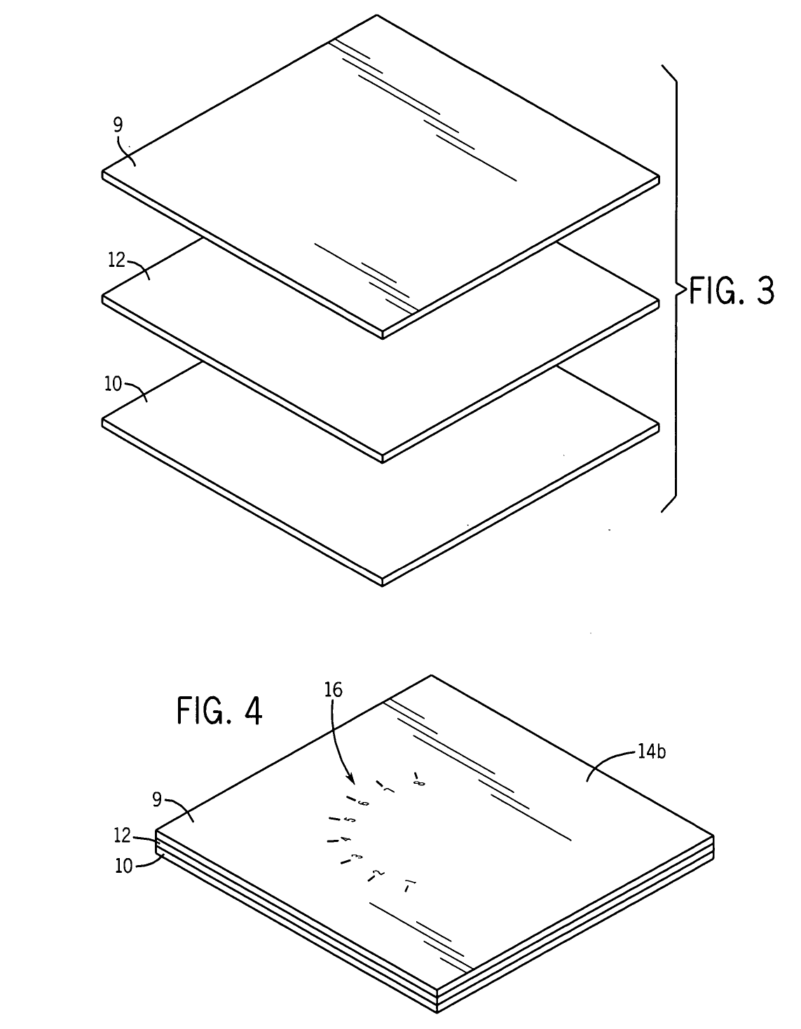

FIGS. 1 and 2 respectively show exploded and perspective views of a first example of an appliqué formed of a protective coating 9, a plastic substrate 10, and a metallic layer 12. The plastic substrate 10 is preferably a clear plastic material sheet. The metallic layer 12 may comprise one or more of a variety of materials that provide the plastic substrate 10 with a metallic appearance when adhered thereto. Examples of metallic layers may include an ink layer having metallic pigment; a tinted metallic foil laminated to the plastic substrate 10; or some other type of metallic film. In addition, or in the alternative, an iridescent or colored foil can be used in place of, or in addition to, the metallic layer 12. The protective coating 9 may comprise a further clear plastic layer or other similar coating. Preferably, as described further below, the protective coating 9 has a higher glass transition temperature than the plastic substrate 10. However, it will be recognized by those skilled in the art that materials different than those described above may be used to achieve the objectives of the present invention.

As shown in FIG. 2, the protective coating 9, plastic substrate 10, and metallic layer 12 are adhered together to form an appliqué 14a. In the illustrated example, the metallic layer 12 is adhered to the bottom of the plastic substrate 10, and a set of light transmissive indicia 16 are printed, etched, or inscribed in the metallic layer 12 in a “reversed layout” such that the numbers are viewable through the front face 13 of the plastic substrate 10. This process is well-known in the art. In the embodiment shown, the light transmissive indicia 16 include a set of numbers, such as those present on a typical speedometer.

The protective coating 9 is adhered to the plastic substrate 10 opposite the metallic layer 12 and serves to protect the plastic layer 10 and metallic layer 12 during forming and other processing, as will be further explained below. Together, the protective coating 9, plastic substrate 10, and metallic layer 12 comprise an appliqué 14a, such as for use as an instrument panel or automotive display panel, or the like.

FIGS. 3 and 4, respectively, show a second example of an appliqué formed from a plastic substrate 10, a metallic layer 12, and a protective coating 9. The metallic layer 12 is adhered to the top of the plastic substrate 10. The protective coating 9 is adhered to the top of the metallic layer 12 and serves to protect the metallic layer 12 and plastic layer 10 during forming and other processing, as will be further explained below. Together, the protective coating 9, metallic layer 12, and plastic substrate 10 comprise an appliqué 14b, such as for use as an instrument panel or automotive display panel, or the like.

A set of light transmissive indicia 16 are printed, etched, or inscribed in the metallic layer 12 such that the numbers are viewable through the protective coating 9.

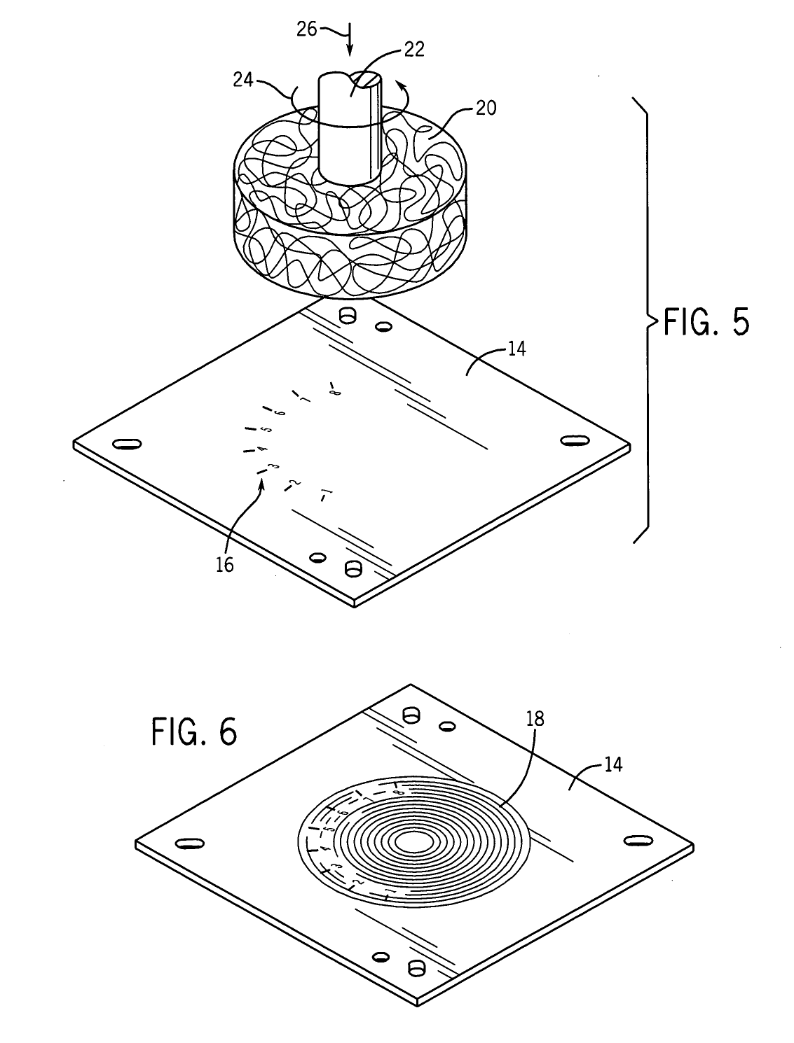

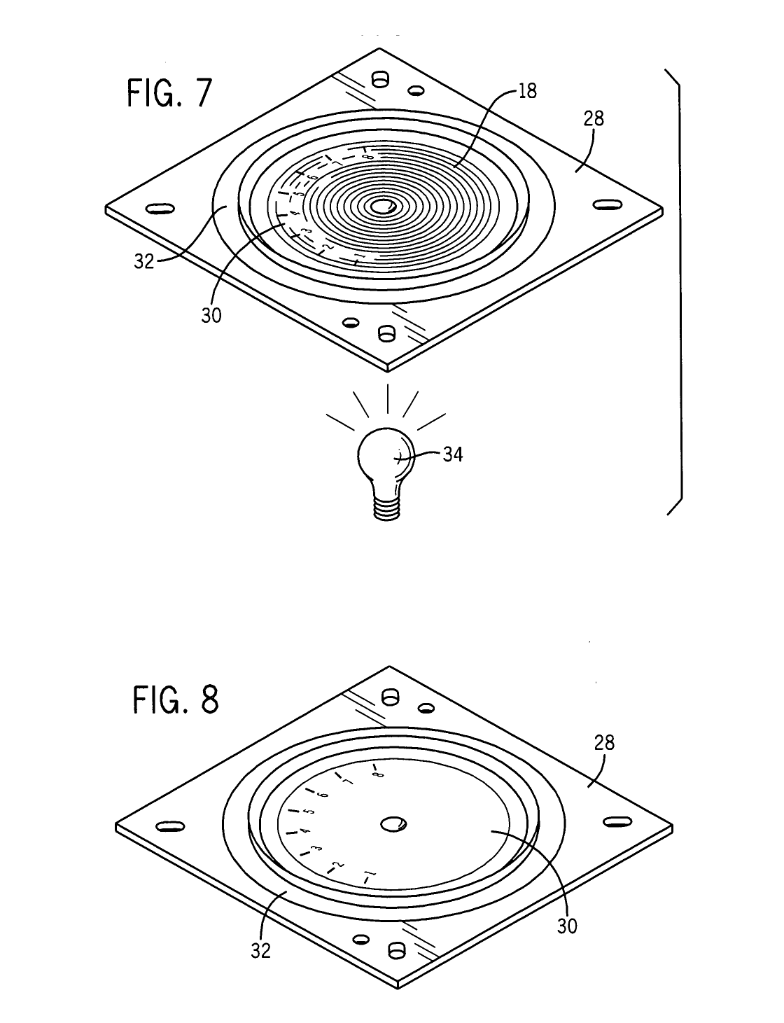

As shown in FIGS. 5 and 6, by the present application, it has been found to be desirable to provide a series of finely configured score lines 18 in the appliqué 14. In the arrangement shown in FIGS. 5 and 6, the score lines are formed in the first, top surface of the coating layer 9, however, it will be recognized by those skilled in the art that the score lines may also, or alternatively be formed in the second, bottom surface of the plastic substrate 12 if the appliqué 14 is formed according to the embodiment shown in FIGS. 1 and 2. The designated pattern of finely configured score lines 18 can comprise circular concentric lines or a brush pattern, or any other selected or random configuration.

The score lines 18 can be formed in the appliqué 14 by any one of a variety of mechanical working processes. An example is shown in FIG. 5 wherein an abrasive pad 20 connected to a mechanical tool 22 is applied to the coating layer 9 of the appliqué 14. The tool 22 is rotated in a circular direction as shown at arrow 24 and applied to the appliqué 14 in the direction shown by the arrow 26. In this manner, the abrasive surface of the pad 20 forms concentric score lines 18 in the appliqué 14. The resultant appliqué 14 has a brush pattern that is circular and generally comprises a plurality of concentric circles. It will be recognized by those skilled in the art that different mechanical working processes and tools may be used to configure the score lines. For example, the lines could be laser-cut.

The glass transition temperature value for the protective coating 9 is preferably higher than the plastic substrate 10, and thus the protective coating 9 serves to protect the plastic substrate 10 and metallic layer 12 during processing, and maintains the definition of the score lines 18. Alternatively, the score lines 18 can be formed directly in the plastic substrate 10, however, this can be disadvantageous because at elevated temperatures during processing, score lines formed in the plastic substrate 10 can melt and lose formation.

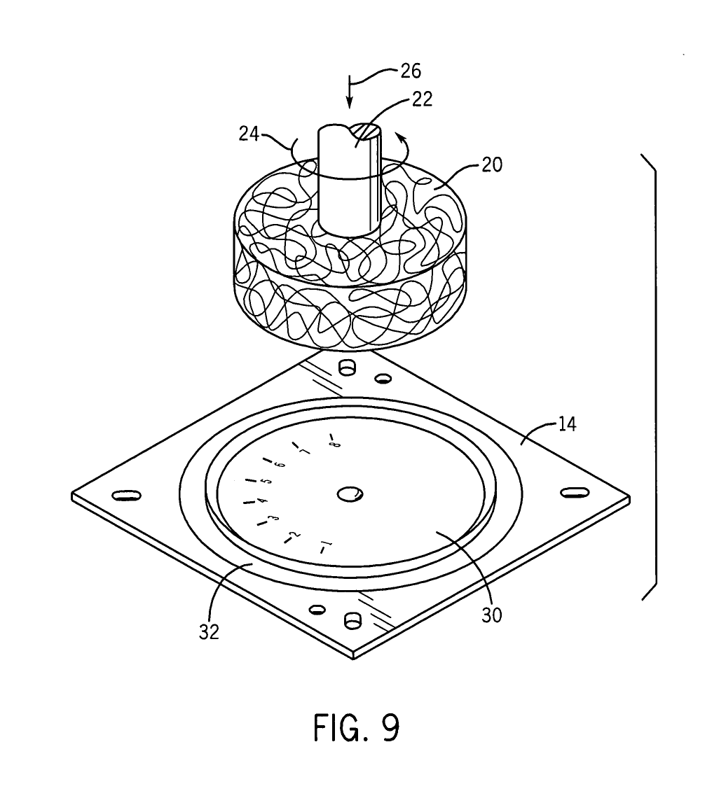

Referring to FIGS. 7 and 8, the appliqué can alternatively comprise a three-dimensional or formed appliqué 28 having a flat planar region 30 and a non-flat, non-planar region 32. In the embodiment shown, the finely configured score lines 18 are formed in the flat planar region 30, per FIG. 9. However, it will be recognized by those skilled in the art that the score lines 18 may also, or alternatively, be formed in the non-flat, non-planar region 32.

Referring to FIG. 7, when the appliqué 28 is back-lit by a light 34, such as a light-emitting diode, the appliqué provides a uniquely appealing visual display.

In the embodiments shown in FIGS. 7-9, the metallic layer 12 preferably comprises a stretchable chrome that conforms to the three-dimensional shape without cracking.

It is recognized that various equivalents, alternatives, and modifications are possible within the scope of the present application.

What is claimed is:

1. An appliqué having a metallic appearance comprising:
a substrate of a plastic material;
a metallic layer formed on said substrate;
finely configured score lines formed in said appliqué.

2. The appliqué according to claim 1 wherein said score lines are formed in said plastic substrate.

3. The appliqué according to claim 1 wherein said metallic layer is a metallic film applied to said substrate.

4. The appliqué according to claim 1 wherein said metallic layer is a metallic ink applied to said substrate.

5. The appliqué according to claim 1 wherein said metallic layer is a metallic foil applied to said substrate.

6. The appliqué according to claim 1 comprising a protective coating formed on said substrate.

7. The appliqué according to claim 6 wherein said score lines are formed in said protective coating.

8. The appliqué according to claim 6 wherein said protective coating is clear plastic.

9. The appliqué according to claim 6 wherein said protective coating has a higher glass transition temperature than said plastic substrate.

10. The appliqué according to claim 1 wherein said score lines are brush lines brushed into said appliqué.

11. The appliqué according to claim 10 wherein said brush lines are brushed into said appliqué in a designated brush pattern.

12. The appliqué according to claim 11 wherein said brush pattern is circular, and said brush lines comprise a plurality of concentric circles.

13. The appliqué according to claim 10 wherein said brush lines are random.

14. The appliqué according to claim 1 wherein said metallic layer has a plurality of light-transmissive indicia regions formed therein for passing light therethrough from a backlight.

15. The appliqué according to claim 1 wherein said substrate and said metallic layer are conformed in a three dimensional shape.

16. The appliqué according to claim 15 wherein said metallic layer is stretchable chrome conforming to said three dimensional shape without cracking.

17. The appliqué according to claim 15 wherein said conformed substrate and metallic layer include a flat planar region adjacent a non-flat non-planar region.

18. The appliqué according to claim 17 wherein said score lines are in said flat planar region.

19. A method for making an appliqué having a metallic appearance comprising:
providing a substrate of a plastic material;
forming a metallic layer on said substrate;
scoring finely configured lines in said appliqué.

20. The method according to claim 19 comprising scoring said lines into said plastic substrate.

21. The method according to claim 19 comprising brushing said lines into said appliqué by spinning one of a brush and said appliqué about an axis relative to the other of said brush and said metallic layer.

22. The method according to claim 19 comprising forming a protective layer on said substrate.

23. The method of claim 22 comprising scoring said lines into said protective layer.

24. The method according to claim 19 comprising forming a plurality of light-transmissive indicia regions in said metallic layer for passing light therethrough from a backlight.

25. The method according to claim 19 comprising forming said substrate and said metallic layer into a three dimensional shape after scoring said lines.

26. The method according to claim 19 comprising forming said substrate and said metallic layer into a three dimensional shape before scoring said lines.

27. The method according to claim 25 wherein said substrate and said metallic layer in said three dimensional shape include a flat planar region adjacent a non-flat non-planar region, and comprising scoring said lines in said flat planar region with a brush by spinning one of said brush and said formed substrate about an axis relative to the other of said brush and said formed substrate.

28. An appliqué having a metallic appearance comprising:
a substrate of a plastic material;
a metallic layer formed on said substrate;
a protective layer formed on said substrate; and
finely configured score lines formed in said protective layer.
